(19) United States
(12) Patent Application Publication
(10) Pub. No.: US 2015/0190844 A1
(43) Pub. Date: Jul. 9, 2015

(54) System and Method for Preparing and Maintaining a Hard Surface

(71) Applicant: Diversey, Inc., Duncan, SC (US)

(72) Inventors: Michelle Boulanger, Whitefish Bay, WI (US); Carmine Savaglio, Kenosha, WI (US); Christopher M. Warner, Burlington, WI (US)

(21) Appl. No.: 14/514,712

(22) Filed: Oct. 15, 2014

Related U.S. Application Data
(60) Provisional application No. 61/891,103, filed on Oct. 15, 2013.

(51) Int. Cl. B05D 3/12; C09D 133/08; B05D 3/00

(52) U.S. Cl. CPC B05D 3/12; B05D 3/007; C09D 133/08

(57) ABSTRACT

A method of polishing a stone surface comprises pre-treating the stone surface, applying a liquid film forming composition to the stone surface, and drying the liquid film forming composition on the stone surface. The pre-treatment includes burnishing the stone surface to form a pretreated stone surface. The liquid film forming composition includes 1 to 10 wt % polymer and 0.1 to 5 wt % wax. The polymer includes acrylate polymer and/or styrene-acrylate copolymer. The dried coating has a thickness of from 0.05 mil to 0.27 mil.

### BACKGROUND

The present invention relates to systems, methods, and compositions for preparing and maintaining hard surfaces, such as floors composed of stone.

Stone floors are typically expensive and time-consuming to maintain. Traditional floor finish systems apply a chemical coating or wax to a stone floor to achieve a glossy surface. Periodically, this coating needs to be stripped and reapplied. Stripping typically involves using harsh chemicals. In addition, many floor finishes require frequent (sometimes daily) burnishing to remove scuffs and/or scratches that mark and/or become embedded in the finishes.

### SUMMARY

In some embodiments, the invention provides a method for preparing a stone surface. The method includes grinding the stone surface while the surface is wet with a honing disc that has a first grit. The method also includes grinding the stone surface while the surface is dry with a polishing disc after the surface is ground with the honing disc. The polishing disc has a second grit that is greater than the first grit. The method further includes burnishing the stone surface with a burnish pad after the surface is ground with the polishing disc. The burnish pad has a third grit that is greater than the second grit. The method also includes applying a liquid protector to the stone surface after the floor is burnished with the burnish pad.

In further embodiments, the invention provides a system for preparing a stone surface. The system includes a burnish pad that can be rotated by a floor cleaning machine and a honing disc that releasably couples to the burnish pad for rotation with the pad. The honing disc has a first grit to polish the stone surface while the surface is wet. The system also includes a polishing disc that is releasably coupled to the burnish pad for rotation with the pad and that has a second grit greater than the first grit to polish the stone surface while the surface is dry.

In some embodiments, the invention provides a system for preparing a stone surface. The system includes a burnish pad that can be rotated by a floor cleaning machine, and a disc releasably coupled to the burnish pad for rotation with the pad. The disc includes a first side having a diamond-impregnated resin and a second side that having coupling member engageable with the burnish pad. The coupling member is permanently affixed to the disc such that the coupling member remains attached to the disc after the disc is removed from the burnish pad.

In further embodiments, the disc includes a side covered with a diamond-impregnated resin and a substantially straight edge that meets the stone surface at approximately 90 degrees when the disc is rotated with the burnish pad.

In some embodiments, the invention provides an apparatus including a burnish pad that can be rotated by a floor cleaning machine, and a disc that is releasably coupled to the burnish pad for rotation with the pad. The disc includes a side covered with a diamond-impregnated resin and a plurality of protrusions formed in the resin. The disc has a thickness of at least approximately 0.15 inches.

In further embodiments, the invention provides a system for preparing a stone surface. The system includes a honing disc that has a first grit to grind the stone surface while the surface is wet. The system also includes a polishing disc that has a second grit greater than the first grit to grind the stone surface while the surface is dry. The system further includes a first burnish pad that has a third grit greater than the second grit to burnish the floor, and a second burnish pad that has a fourth grit greater than the third grit to burnish the floor. The honing disc and the polishing disc are operable to releasably couple to the second burnish pad.

In some embodiments, the invention provides a liquid film forming composition comprising from about 1 wt % to about 10 wt % polymer and about 0.1 wt % to about 5 wt % wax, the polymer comprising at least one of an acrylate polymer, a styrene-acrylate copolymer, and a combination thereof.

Other aspects of the invention will become apparent by consideration of the detailed description and accompanying drawings.

### BRIEF DESCRIPTION OF THE DRAWINGS

FIG. 1 is a perspective view of a floor surfacing machine for preparing a hard floor.

FIG. 2 is a perspective view of another floor surfacing machine for preparing a hard floor.

FIG. 3 illustrates a burnish pad for use with a floor surfacing machine and embodying aspects of the invention.

FIG. 4 illustrates another burnish pad for use with a floor surfacing machine.

FIG. 5 illustrates a honing disc for use with the burnish pad of FIG. 4.

FIG. 5A is a side perspective view of the honing disc of FIG. 5.

FIG. 6 illustrates a polishing disc for use with the burnish pad of FIG. 4.

FIG. 7 is a perspective view of a bottom of the burnish pad of FIG. 4 including three honing discs.

FIG. 8 is a perspective view of a bottom of the burnish pad of FIG. 4 including four polishing discs.

FIG. 9 is a perspective view of a floor finish application tool for applying a liquid protector to a stone floor.

FIG. 10 is a flow chart outlining a method of polishing and maintaining a stone floor.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

The present disclosure is also not limited in its disclosure to the specific details of construction, arrangement of components, or method steps set forth herein. The compositions and methods disclosed herein are capable of being made, practiced, used, carried out and/or formed in various ways. The phraseology and terminology used herein is for the purpose of description only and should not be regarded as limiting. Ordinal indicators, such as first, second, and third, are used in the description and the claims to refer to various structures or method steps, but are not meant to be construed to indicate any specific structures or steps, or any particular order or configuration to such structures or steps. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Also, no language in the specification, and no structures shown in the drawings, should be construed as indicating that any non-claimed element is essential to the practice of the invention. The use herein of the terms “including,” “comprising,” or “having,” and variations thereof, is meant to encompass the items listed thereafter and equivalents thereof, as well as additional items. Unless specified or limited otherwise, the terms “mounted,” “connected,” “supported,” and “coupled” and variations thereof encompass both direct and indirect mountings, connections, supports, and couplings. Further, “connected” and “coupled” are not restricted to physical or mechanical connections or couplings.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is used synonymously with the term “approximately”, and is meant to indicate that values very near to the recited amount are included in that amount, such as values that could or naturally would be accounted for due to manufacturing tolerances, instrument and human error in forming measurements, and the like. Illustratively, the use of the term “about” indicates that values slightly outside the cited values, namely, plus or minus 10%. Such values are thus encompassed by the scope of the claims reciting the terms “about” and “approximately.”

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein. All references cited herein are fully incorporated by reference, unless explicitly indicated otherwise. The present disclosure shall control in the event there are any disparities.

### DETAILED DESCRIPTION

### System for Preparing and Maintaining Hard Surfaces

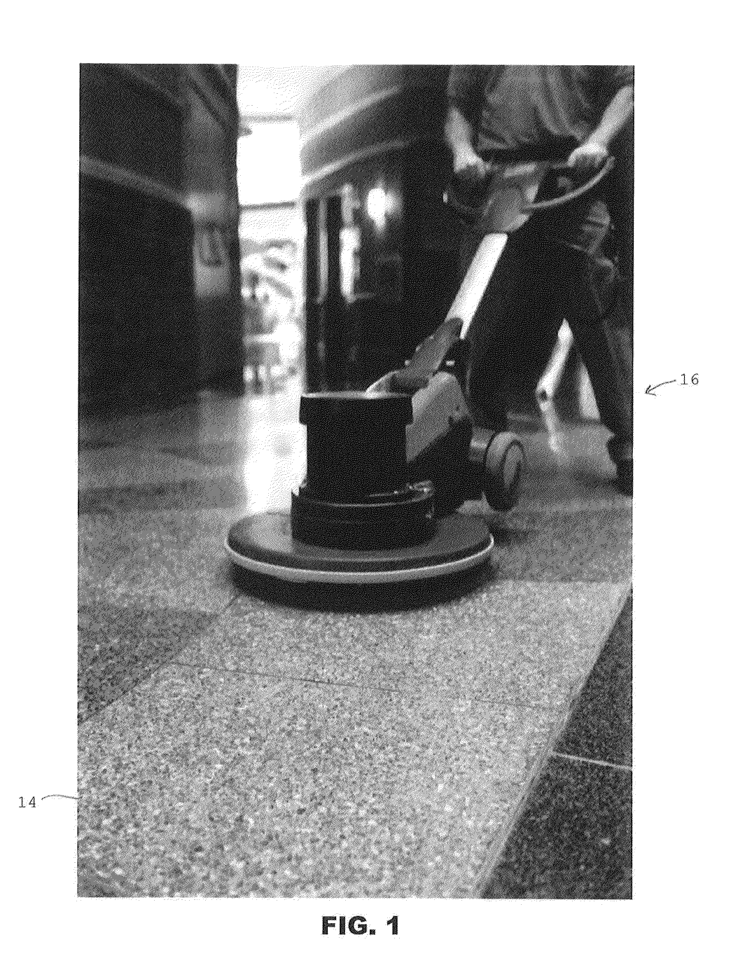

FIGS. 1-10 illustrate a system and process for cleaning, polishing, and maintaining a stone or other hard non-stone surface 14, such as a floor. The system and method may be used on surfaces made of, for example, terrazzo, polished or bare concrete, decorative (e.g., stained or dyed) concrete, granite, marble, travertine, other porous or non-porous stone materials. The system utilizes one or more floor machines (e.g., swing machines, auto scrubbers, burnishers, etc.) in combination with diamond-impregnated pads and discs to create a long term gloss appearance on the surface 14. Using this system, the surface 14 can be polished using a wet grinding process and a thy-grinding process, burnished, and then coated with a liquid film forming composition. After initial installation (i.e., performance of the process described below), no further chemical stripping of the stone surface is necessary to maintain the surface to have a relatively high gloss.

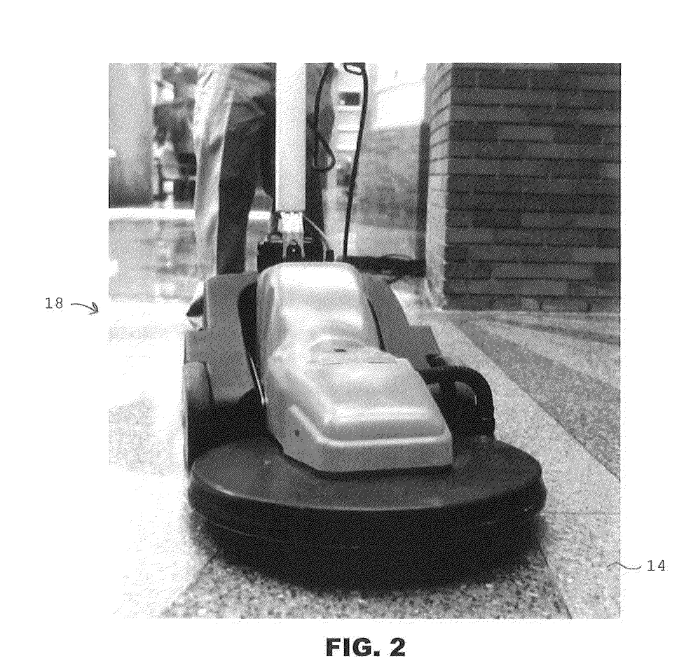

FIG. 1 shows an exemplary floor cleaning and preparation machine 16 that can be used in the system. The illustrated floor cleaning machine 16 is a swing machine. In some embodiments, the swing machine 16 may be a “TASKI Ergodisc 175” swing machine manufactured by Diversey. FIG. 2 illustrates another exemplary floor cleaning machine 18 that can be used in the system. The floor cleaning machine 18 illustrated in FIG. 2 is a burnisher. In some embodiments, the burnisher 18 may be a “TASKI Ergodisc 2000” burnisher manufactured by Diversey. Each of the swing machine 16 and the burnisher 18 is maneuverable by a user over the surface 14 to prepare (e.g., at least one of grind, burnish, and polish) the surface 14 for a floor finish. In some embodiments, both machines 16, 18 can be used in the system to clean and prepare (e.g., grind, burnish, polish, etc.) the surface 14. In other embodiments, a single floor cleaning machine (e.g., either the swing machine 16 or the burnisher 18) may be used to perform all surface preparation tasks, rather than separate machines. For purposes of describing the system, the term “prep machine” will be used to generically describe the swing machine 16 and the burnisher 18.

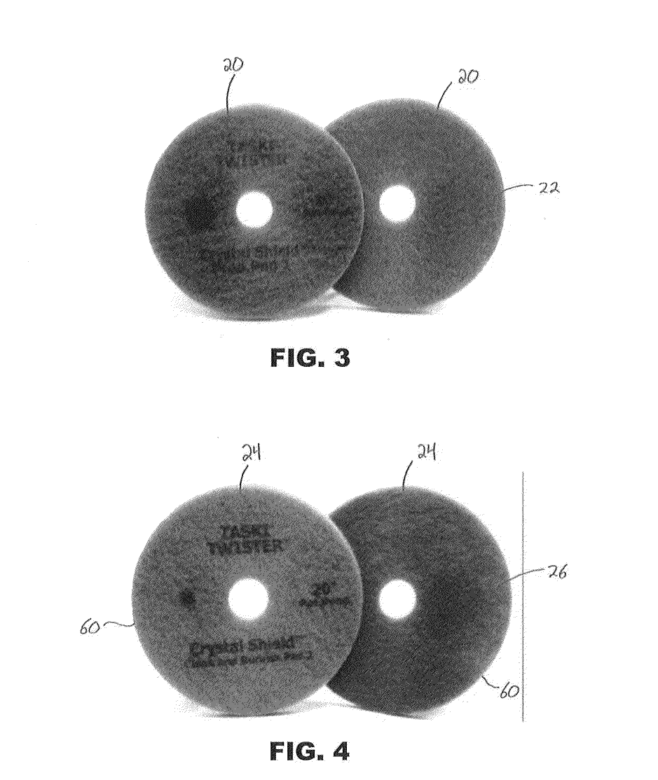

FIG. 3 shows a first prep or burnish pad 20 that can be attached to the prep machine to prepare the surface 14. The illustrated burnish pad 20 is generally circular and has a diameter of approximately 20 inches, although other shapes and sizes for the burnish pad 20 are possible. The burnish pad 20 is attachable to a lower surface of the prep machine and includes an outer face 22. The pad 20 can be driven (e.g., rotated) by the prep machine to burnish the surface 14 with the outer face 22. The first burnish pad 20 is attached to the machine to burnish an uncoated surface 14. The pad 20 includes diamond material that is bound or adhered to the pad 20 using resin (or another suitable adhesive) such that the pad 20 is diamond-impregnated. Although diamond-impregnated material is preferred, in other embodiments, other abrasive materials can instead be used a desired, including pads impregnated, coated, or otherwise treated with metallic abrasives such as silicon carbide, aluminum oxide, cubic boron nitride, or the like. Generally, the amount of diamond or other abrasive material disposed in the resin at least partially defines a grit of the pad 20. The illustrated first burnish pad 20 is a relatively coarse pad that has, for example, a first grit of approximately 1500.

FIG. 4 illustrates a second burnish pad 24 for use with the prep machine. The illustrated second burnish pad 24 is a clean-and-burnish pad and is generally circular with a diameter of approximately 20 inches, although other shapes and sizes for the burnish pad 24 are possible. The burnish pad 24 is attachable to the lower surface of the cleaning machine and includes an outer face 26. The second burnish pad 24 can be driven (e.g., rotated) by the prep machine to burnish a coated surface 14 with the outer face 26, which cleans the surface 14. The second burnish pad 24 includes diamond material that is bound or adhered to the pad 24 using resin (or another suitable adhesive) such that the pad 24 is diamond-impregnated. Although diamond-impregnated material is preferred, in other embodiments, other abrasive materials can instead be used as desired, including pads impregnated, coated, or otherwise treated with metallic abrasives such as silicon carbide, aluminum oxide, cubic boron nitride, or the like. The illustrated second burnish pad 24 is defined by a second grit (e.g., 3000) that is finer or less coarse than the first grit of the first burnish pad 20. The illustrated second burnish pad 24 has a second grit of approximately 3000, although the pad 24 can have coarser or finer grits.

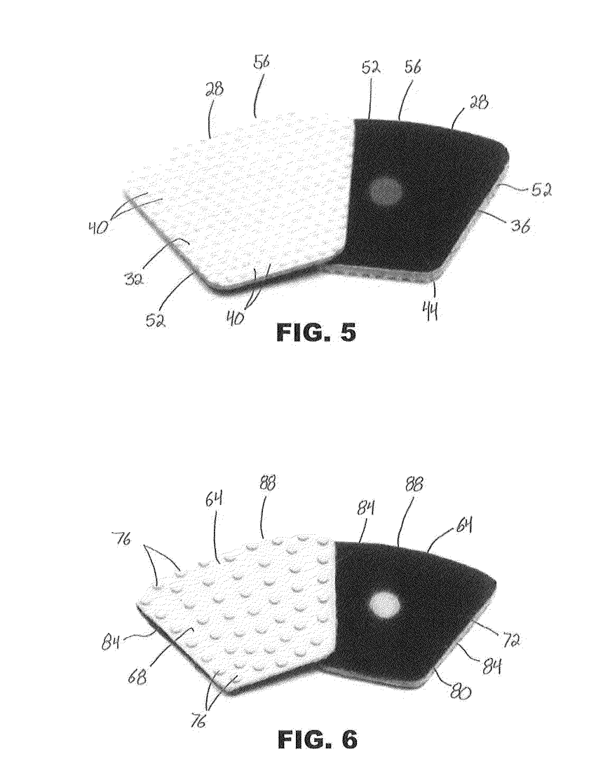

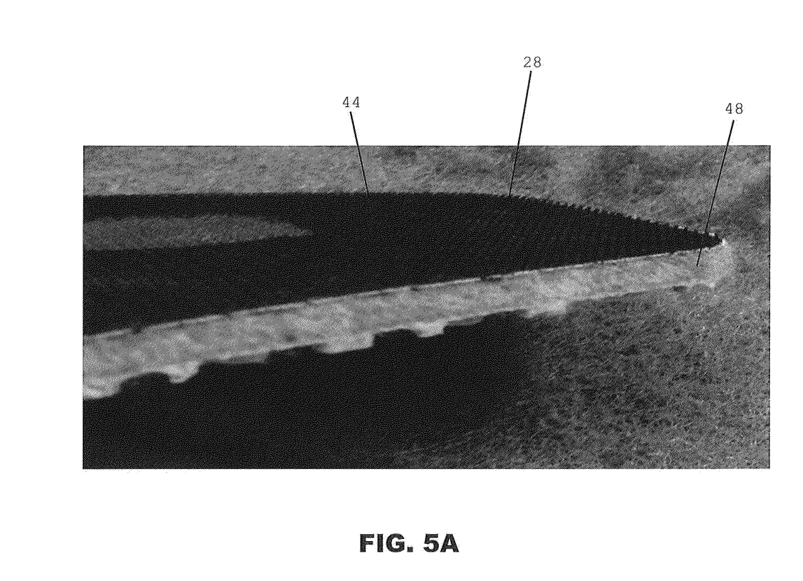

FIG. 5 illustrates a honing disc 28 that can be detachably coupled to the burnish pad 24. The honing disc 28 includes a first side 32 and a second side 36. The first side 32 is covered with a diamond-impregnated resin, and relatively small projections or protrusions 40 are formed in the resin and extend outwardly from the first side 32 of the disc 28. Although diamond-impregnated material is preferred, in other embodiments, other abrasive materials can instead be used as desired, including pads impregnated, coated, or otherwise treated with metallic abrasives such as silicon carbide, aluminum oxide, cubic boron nitride, or the like. Each protrusion 40 can have a diameter or width of approximately 0.1 to 0.5 inches. In other embodiments, each protrusion can have a diameter or width of approximately 0.1 to 0.3 inches. Also, each protrusion 40 can initially extend approximately 0.05 to 0.25 inches from the first side 32, but may wear down as the honing disc 28 is used to grind and polish the surface 14. In other embodiments, each protrusion 40 can initially extend approximately 0.05 to 0.1 inches from the first side. In the illustrated embodiment, each protrusion 40 has a diameter of approximately 0.21 inches and initially extends approximately 0.08 inches from the first side 32. In some embodiments, the honing disc 28 can include non-circular protrusions.

The diamond-impregnated resin and the protrusions 40 define a third grit of the honing disc 28 that is coarser than the second grit to provide an abrasive for the surface 14. As illustrated, the third grit is between about 200 and 400, although grit of the protrusions 40 can be outside this range. For example, in some embodiments the third grit is no greater than about 100 and/or is no finer than about 1,500. The protrusions 40 can be positioned or arranged in spaced relationship on the first side 32 so that the honing disc 28 has a desired protrusion density (e.g., no less than approximately 5 protrusions per square inch and/or no greater than about 20 protrusions per square inch) to achieve specific grinding and polishing characteristics (e.g., gloss) for the surface 14. In some embodiments, the protrusion density on the first side 32 of the honing disc 28 is approximately 8 to 10 protrusions per square inch.

The area of diamond-impregnated resin that contacts the surface 14 during use of the honing disc 28 defines a total protrusion surface area of the honing disc 28. The honing disc 28 can be sized so that the total protrusion surface area on the honing disc 28 is, for example, no less than approximately 3 square inches and/or no greater than approximately 10 square inches. In other embodiments, the total protrusion surface area on the honing disc 28 is approximately 5 to 7 square inches. In the illustrated embodiment, the protrusions 40 are spaced to have a density of approximately 8.9 protrusions per square inch and the total protrusion surface area on each honing disc 28 is approximately 5.9 square inches. In other embodiments, the protrusions 40 may have other suitable shapes, dimensions, or protrusion densities.

With continued reference to FIG. 5, the second side 36 of the honing disc 28 includes a coupling member 44. The coupling member 44 is engageable with the outer face 26 of the second burnish pad 24 to releasably secure the honing disc 28 on the pad 24. In some embodiments, the coupling member 44 may engage with the outer face 22 of the first burnish pad 20 to releasably secure the honing disc 28 on the first burnish pad 20. In the illustrated embodiment, the coupling member 44 includes hook fasteners, such as hook material of hook and loop fastener material. In other embodiments, the coupling member 44 may also or alternatively include other suitable types of fasteners. The illustrated coupling member 44 is permanently affixed (e.g., adhered) to the honing disc 28 so that the coupling member 44 remains attached to the honing disc 28 after the disc 28 is removed from the pad 24, and therefore is disposed of with the honing disc 28 after the honing disc 28 has been spent.

Referring to FIG. 5A, the honing disc 28 generally has a laminate construction. In the illustrated embodiment, a compressed fibrous material 48 is sandwiched between the diamond-impregnated resin and the coupling member 44. The diamond-impregnated resin is coated directly onto one side of the fibrous material 48, while the coupling member 44 is glued directly onto the opposite side of the fibrous material 48. In other embodiments, an intermediate layer may be positioned between the diamond-impregnated resin and the fibrous material 48 and/or between the coupling member 44 and the fibrous material 48. In further embodiments, the honing disc 28 may be formed using other suitable construction techniques.

Referring back to FIG. 5, the honing disc 28 can be connected to the outer face 26 of the second burnish pad 24 to rotate with the burnish pad 24 to grind or polish the surface 14, as described in detail below. The illustrated honing disc 28 is generally sector-shaped (e.g., trapezoidal or wedge) and includes two radially-extending edges 52 and a curved outer edge 56. The radially-extending edges 52 are generally straight edges that meet a surface 14 at approximately 90 degrees when rotated. The curved outer edge 56 is contoured to generally match an outer edge 60 of the burnish pad 24. In some embodiments, the sector-shaped honing disc 28 extends through an arc of no less than approximately 10 degrees and/or no greater than approximately 90 degrees. In other embodiments, the honing disc 28 extends through an arc of no less than approximately 30 degrees and/or no greater than approximately 60 degrees. In some embodiments, the sector-shaped honing disc 28 has an annular width adjacent the curved outer edge 56 of no less than approximately 3 inches and/or no greater than approximately 7 inches. In other embodiments, the annular width adjacent the curved outer edge 56 is no less than approximately 4 inches and/or is no greater than approximately 6 inches. Also, in some embodiments the sector-shaped honing disc 28 has a width opposite the curved outer edge 56 of no less than approximately 1 inch and/or no greater than approximately 5 inches. In other embodiments, the width of honing disc 28 opposite the curved outer edge 56 is no less than approximately 1 inch and/or is no greater than approximately 4 inches. In some embodiments, the sector-shaped honing disc 28 has a radial length of no less than approximately 1 inch and/or no greater than approximately 8 inches. In other embodiments, the radial length of the sector-shaped honing disc 28 is approximately 3 to 6 inches. Also, in some embodiments the honing disc 28 has a thickness of no less than approximately 0.1 inches and/or no greater than approximately 0.75 inches (not including the height of the protrusions 40). In other embodiments, the honing disc 28 has a thickness of approximately 0.2 to 0.4 inches (again, not including the height of the protrusions 40). In the illustrated embodiment, the sector-shaped honing disc 28 extends through an arc of approximately 40 degrees, has a maximum width of approximately 5 inches, has a minimum width of approximately 3 inches, has a height of approximately 4.5 inches, and has a thickness of approximately 0.3 inches. In other embodiments, the honing disc 28 may have a different shape or other suitable dimensions.

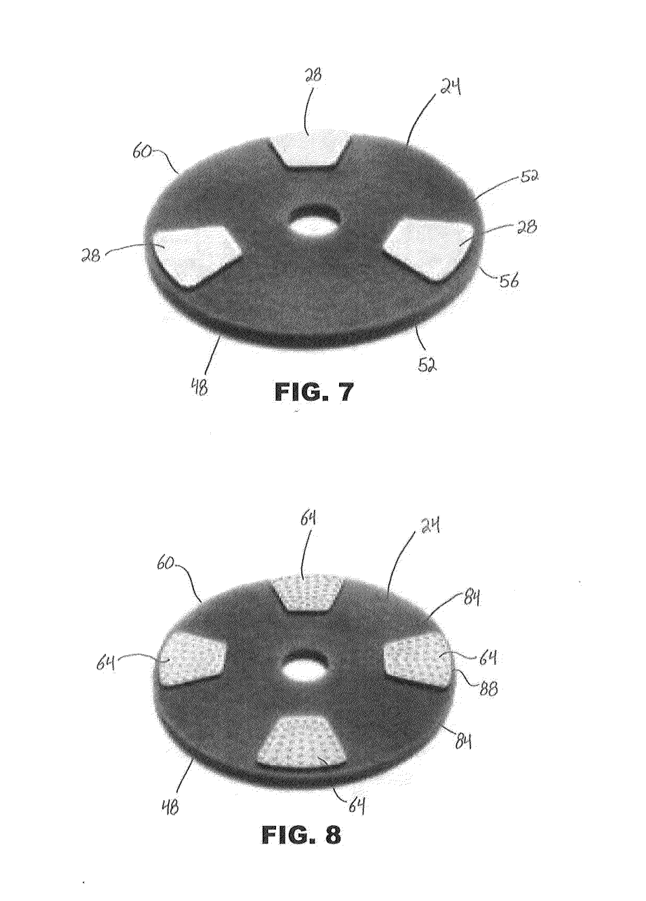

As shown in the FIG. 7, three honing discs 28 are coupled to the second burnish pad 24 to rotate with the burnish pad 24. The honing discs 28 are positioned on the burnish pad 24 so that the curved outer edge 56 of each disc 28 is substantially parallel to the outer edge 60 of the pad 24. The illustrated honing discs 28 are circumferentially evenly spaced around the perimeter of the pad 24 by approximately 120 degrees (center-to-center of each honing disc 28). In other embodiments, fewer or more honing discs 28 may be coupled to the burnish pad 24 and spaced at substantially equal angular distances (e.g., approximately 90 degrees or 180 degrees center-to-center). For example, when grinding terrazzo, three honing discs 28 may be attached to the pad 24, whereas when grinding polished concrete, four honing discs 28 may be attached to the pad 24.

FIG. 6 illustrates a polishing disc 64 that can be detachably coupled to the burnish pad 24. The polishing disc 64 includes a first side 68 and a second side 72. The first side 68 of the polishing disc 64 is covered with a diamond-impregnated resin. Although diamond-impregnated material is preferred, in other embodiments, other abrasive materials can instead be used as desired, including pads impregnated, coated, or otherwise treated with metallic abrasives such as silicon carbide, aluminum oxide, cubic boron nitride, or the like. Relatively large projections or protrusions 76 are formed in the resin and extend outwardly from the first side 68 of the disc 64. Each protrusion 76 can have a diameter or width of approximately 0.1 to 0.75 inches. In other embodiments, each protrusion 76 has a diameter or width of approximately 0.25 to 0.4 inches. Also, each protrusion 76 can initially extend approximately 0.05 to 0.25 inches from the first side 68, but may wear down as the polishing disc 64 is used to grind and polish the surface 14. In other embodiments, each protrusion 40 can initially extend approximately 0.05 to 0.1 inches from the first side. In the illustrated embodiment, each protrusion 76 has a diameter of approximately 0.32 inches and initially extends approximately 0.08 inches from the first side 68. In some embodiments, the polishing disc 64 can include non-circular protrusions.

The diamond-impregnated resin and the protrusions 76 define a fourth grit of the polishing disc 64 that is finer or less coarse than the third grit to grind and polish the surface 14. As illustrated, the third grit is approximately 800, although the protrusions 76 can be arranged on the first side 68 so that the fourth grit is higher or lower than 800. For example, in some embodiments the fourth grit is no greater than about 400 and/or is no finer than about 1,500. The protrusions 76 can be positioned or arranged in spaced relationship on the first side 68 so that the polishing disc 64 has a desired protrusion density (e.g., no less than approximately 1 protrusion per square inch and/or no greater than approximately 8 protrusions per square inch). In some embodiments, the protrusion density on the first side 68 of the polishing disc 64 is approximately 1.5 to 3.5 protrusions per square inch. As illustrated, the polishing disc has a protrusion density of approximately 2.5 protrusions per square inch.

The area of diamond-impregnated resin that contacts the surface 14 during use of the polishing disc 64 defines a total protrusion surface area of the polishing disc 64. The polishing disc 64 can be sized so that the total protrusion surface area on the polishing disc 64 is, for example, no less than approximately 2 square inches and/or no greater than approximately 7 square inches. In other embodiments, the total protrusion surface area on the polishing disc 64 is approximately 3 to 5 square inches. In the illustrated embodiment, the total protrusion surface area on the polishing disc 64 is approximately 3.8 square inches. In other embodiments, the protrusions 76 may have other suitable shapes or dimensions.

With continued reference to FIG. 6, the second side 72 of the polishing disc 64 includes a coupling member 80. The coupling member 80 is engageable with the outer face 26 of the second burnish pad 24 to releasably attach the polishing disc 64 on the pad 24. In some embodiments, the coupling member 80 may engage with the outer face 22 of the first burnish pad 20 to releasably attach the polishing disc 64 on the pad 22. In the illustrated embodiment, the coupling member 80 includes hook fasteners, such as hook material of hook and loop fastener material. In other embodiments, the coupling member 80 may also or alternatively include other suitable types of fasteners. The illustrated coupling member 80 is permanently affixed to the polishing disc 64 such that the coupling member 80 remains attached to the polishing disc 64 after the disc 64 is removed from the pad 24, and therefore is disposed of with the polishing disc 64 after the honing disc 64 has been spent.

Similar to the honing disc 28, the polishing disc 64 may have a laminate construction with a compressed fibrous material sandwiched between the diamond-impregnated resin and the coupling member 80.

The polishing disc 64 also can be attached to the outer face 26 of the second burnish pad 24 to rotate with the burnish pad 24. The illustrated polishing disc 64 is generally sector-shaped (e.g., trapezoidal or wedge) and includes two radially-extending edges 84 and a curved outer edge 88. The radially-extending edges 84 are generally straight edges that meet surface 14 at approximately 90 degrees when rotated. The curved outer edge 88 is contoured to generally match the outer edge 60 of the burnish pad 24. In some embodiments, the sector-shaped polishing disc 64 extends through an arc of no less than approximately 10 degrees and/or no greater than approximately 90 degrees. In other embodiments, the polishing disc 64 extends through an arc of no less than approximately 30 degrees and/or no greater than approximately 60 degrees. In some embodiments, the sector-shaped polishing disc 64 has an annular width adjacent the curved outer edge 88 of no less than approximately 3 inches and/or no greater than approximately 7 inches. In other embodiments, the annular width adjacent the curved outer edge 88 is no less than approximately 4 and/or is no greater than approximately 6 inches. Also, in some embodiments, the sector-shaped polishing disc 64 has a width opposite the curved outer edge 88 of no less than approximately 1 inch and/or no greater than approximately 5 inches. In other embodiments, the width of the polishing disc 64 opposite the curved outer edge 88 is no less than approximately 1 inch and/or is no greater than approximately 4 inches. In some embodiments, the sector-shaped polishing disc 64 has a radial length of no less than approximately 1 inch and/or no greater than approximately 8 inches. In other embodiments, the radial length of the sector-shaped polishing disc 64 is approximately 3 to 6 inches. Also, in some embodiments, the polishing disc 64 has a thickness of no less than approximately 0.1 inches and/or no greater than approximately 0.75 inches (not including the height of the protrusions 76). In other embodiments, the polishing disc 64 has a thickness of approximately 0.15 to 0.35 inches (again, not including the protrusions 76). In the illustrated embodiment, the sector-shaped polishing disc 64 extends through an arc of approximately 40 degrees, has a maximum width of approximately 5 inches, has a minimum width of approximately 3 inches, has a height of approximately 4.5 inches, and has a thickness of approximately 0.25 inches. In other embodiments, the polishing disc 64 may have a different shape or other suitable dimensions.

As shown in the FIG. 8, four polishing discs 64 are coupled to the second burnish pad 24 to rotate with the burnish pad 24. The polishing discs 64 are positioned on the burnish pad 24 so that the curved outer edge 88 of each disc 64 is substantially parallel to the outer edge 60 of the pad 24. The illustrated polishing discs 64 are circumferentially evenly spaced around the perimeter of the pad 24 by approximately 90 degrees (center-to-center of each disc 64). In other embodiments, fewer or more polishing discs 64 may be coupled to the burnish pad 24. For example, when grinding terrazzo, three polishing discs 64 may be connected to the pad 24, whereas when grinding polished concrete, decorative concrete, or marble granite, four polishing discs 64 may be connected to the pad 24.

In operation, the second burnish pad 24 is attached to the prep machine and the honing discs 28 are attached to the second burnish pad 24 to rotate with the pad 24 at a high speed. The honing discs 28 smooth and flatten the surface 14 and prepare the surface for polishing. The surface being cleaned should remain wet when being ground by the honing discs 28. During use, a set of honing discs 28 attached to the pad 24 may cover approximately 7500 square-feet of terrazzo, marble, or granite or approximately 5000 square-feet of concrete before becoming completely worn.

In the illustrated system, the polishing discs 64 are attached to the second burnish pad 24 after the honing discs 28 are removed. The polishing discs 64 rotate with the pad 24 at a high speed by the prep machine to further smooth and flatten the surface 14 after the honing discs 28 are used. In particular, the polishing discs 64 create a shiny surface and prepare the surface 14 for burnishing. The surface being cleaned should remain dry when being ground by the polishing discs 64. During use, a set of polishing discs 64 attached to the second burnish pad 24 may cover approximately 3750 square-feet of terrazzo, marble, or granite or approximately 2500 square-feet of concrete before becoming completely worn.

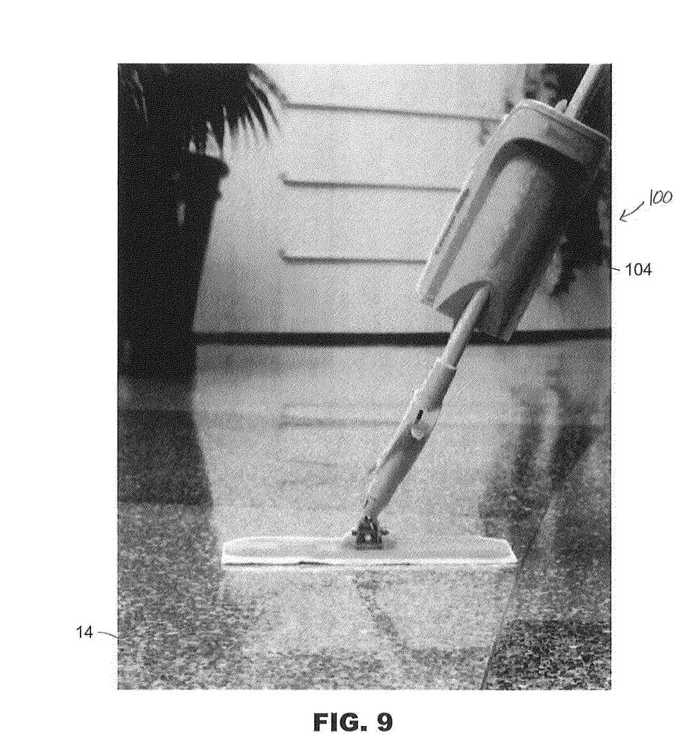

FIG. 9 illustrates an exemplary floor finish application tool 100 that can be used to apply a liquid film forming composition, or floor finish, to the surface 14 after the floor is polished and burnished by the prep machine with the pads 20, 24 and the discs 28, 64. The application tool 100 can apply a suitable fluid to protect the stone floor against scratching, scuffing, and stains. The fluid may also provide slip resistance on the floor. In some embodiments, the floor finish application tool 100 may be the floor finish application tool described in U.S. Publication No. 2010/0047459, the entire contents of which are incorporated by reference herein.

### Liquid Film Forming Composition

The liquid film forming composition may be applied to a hard surface, whereupon the composition dries to form a coating. The film forming compositions described herein are formulated specifically for application to stone surfaces that have been ground, polished and burnished (i.e., pretreated) according to the processes described above. Known compositions that may be suitable for application to stone surfaces that have not been pretreated according to the process described herein have been found to be unsuitable for forming desirable coatings on stone surfaces that have been pretreated according to the processes described above.

The compositions of the liquid film forming composition generally may comprise a polymer and a wax. The composition may comprise from about 1 wt % to about 10 wt % polymer and from about 0.1 wt % to about 5 wt % wax. The polymer may comprise at least one of an acrylate polymer, a styrene-acrylate copolymer, and a combination thereof. Other features of the compositions will be understood according to the details described below.

### Polymers

The polymer of the compositions described herein may comprise a plurality of acrylate and/or styrene monomer units

At least zero, at least about 5 percent, at least about 10 percent, at least about 15 percent, at least about 20 percent, at least about 25 percent, at least about 30 percent, at least about 35 percent, or at least about 40 percent of the monomer units may be styrene monomer units. Less than about 45 percent, less than about 40 percent, less than about 35 percent, less than about 30 percent, less than about 25 percent, less than about 20 percent, less than about 15 percent, less than about 10 percent, or less than about 5 percent of the monomer units may be styrene monomer units. For example, zero to about 45 percent of the monomer units may be styrene monomer units. Styrene monomer units may include, for example, styrene and substituted styrene monomers, such as without limitation, alpha-methyl styrene, para-methyl styrene, tert-butyl styrene, and vinyl toluene. Suitably, the styrene monomer units may be styrene monomers.

At least about 55, at least about 60, at least about 65, at least about 70 percent, at least about 75 percent, at least about 80 percent, at least about 85 percent, at least about 90 percent, or at least about 95 percent of the monomer units may be acrylate monomer units. Less than about 100 percent, less than about 95 percent, less than about 90 percent, less than about 85 percent, less than about 80 percent, less than about 75 percent, less than about 70 percent, less than about 65 percent, or less than about 60 percent of the monomer units may be acrylate monomer units. For example, about 55 to about 100 percent of the monomer units may be acrylate monomer units. Acrylate monomer units may include, for example, acrylate and methacrylate monomers, such as, without limitation, methyl methacrylate, tert-butyl methacrylate, isobutyl methacrylate, ethyl methacrylate, butyl methacrylate, hexyl methacrylate, lauryl methacrylate, benzyl methacrylate, cyclohexyl methacrylate, isobornyl methacrylate, stearyl methacrylate, hydroxyethyl methacrylate, hydroxypropyl methacrylate, gylcidyl methacrylate, acetoacetoxyethyl methacrylate, acetoacetoxypropyl methacrylate, acetoacetoxybutyl methacrylate, 2,3-di(acetoacetoxy)propyl methacrylate, dimethylaminoethyl methacrylate, tert-butylaminoethyl methacrylate, butyl acrylate, 2-ethylhexyl acrylate, methyl acrylate, ethyl acrylate, propyl acrylate, isopropyl acrylate, hexyl acrylate, isobutyl acrylate, tert-butyl acrylate, benzyl acrylate, isobomyl acrylate, cyclohexyl acrylate, laurel acrylate, hydroxyethyl acrylate, hydroxypropyl acrylate, gylcidyl acrylate, and acetoacetoxyethyl acrylate; acrylic amides such as, without limitation, acrylamide, methacrylamide, N-methyl acrylamide, N-methyl methacrylamide, N-methylol acrylamide, N-methylol methacrylamide, diacetoneacrylamide, and diacetonemethacrylamide; and α,β-ethylenically unsaturated mono- and dicarboxylic acids such as, without limitation, methacrylic acid, acrylic acid, crotonic acid, maleic acid, fumaric acid, and itaconic acid. In some embodiments, each acrylate monomer unit independently may be selected from methyl methacrylate, butyl acrylate, methacrylic acid, isobutyl methacrylate, 2-ethylhexylacrylate, and hydroxyethyl methacrylate. Suitably, each acrylate monomer unit independently may be selected from methyl methacrylate, butyl acrylate, and methyl acrylic acid.

The polymer may have a glass transition temperature (T_{g}) greater than about 45° C., greater than about 50° C., greater than bout 55° C., greater than about 60° C., greater than about 65° C., greater than about 70° C., greater than about 75° C., greater than about 80° C., greater than about 85° C., greater than about 90° C., greater than about 95° C., greater than about 100° C., greater than about 105° C., or greater than about 110° C. The polymer may have a T_{g} less than about 115° C., less than about 110° C., less than about 105° C., less than about 100° C., less than about 95° C., less than about 90° C., less than about 85° C., less than about 80° C., less than about 75° C., less than about 70° C., less than about 65° C., less than about 60° C., less than about 55° C., or less than about 50° C. For example, the polymer may have a T_{g} from about 45° C. to about 115° C., from about 50° C. to about 105° C., from about 55° C. to about 95° C., or from about 60 to about 85° C., among others. In some embodiments, the T_{g} may be from about 62° C. to about 99° C. In other embodiments, the T_{g} may be from about 62° C. to about 76° C. Suitably, the polymer may have a T_{g} of about 60-70° C., such as a T_{g} of 67° C.

The polymer also may have an acid number greater than about 20, greater than about 25, greater than about 30, greater than about 35, greater than about 40, greater than about 45, greater than about 50, greater than about 55, greater than about 60, greater than about 65, greater than about 70, greater than about 75, greater than about 80, greater than about 85, greater than about 90, greater than about 95, greater than about 100, greater than about 105, greater than about 110, greater than about 115, greater than about 120, greater than about 125, greater than about 130, greater than about 135, greater than about 140, or greater than about 145. The polymer may have an acid number less than about 150, less than about 145, less than about 140, less than about 135, less than about 130, less than about 125, less than about 120, less than about 115, less than about 110, less than about 105, less than about 100, less than about 95, less than about 90, less than about 85, less than about 80, less than about 75, less than about 70, less than about 65, less than about 60, less than about 55, less than about 50, less than about 45, less than about 40, less than about 35, less than about 30, or less than about 25. The polymer may have an acid number from about 20 to about 150, from about 25 to about 140, from about 30 to about 130, from about 35 to about 120, from about 40 to about 110, from about 45 to about 100, or from about 50 to about 90. Suitably, the polymer may have an acid number from about 50 to about 80, such as acid number of about 68. Acid number refers to the amount of KOH required to fully neutralize a given dry sample of polymer, and is defined as milligrams (“mg”) of KOH/dry gram of polymer.

The liquid film forming composition may comprise at least about 1 wt %, at least about 2 wt %, at least about 3 wt %, at least about 4 wt %, at least about 5 wt %, at least about 6 wt %, at least about 7 wt %, at least about 8 wt %, or at least about 9 wt % polymer. The liquid film forming composition may comprise less than about 10 wt %, less than about 9 wt %, less than about 8 wt %, less than about 7 wt %, less than about 6 wt %, less than about 5 wt %, less than about 4 wt %, less than about 3 wt % or less than about 2 wt % polymer. The liquid film forming composition may comprise from about 1 wt % to about 10 wt % polymer, such as from about 2 wt % to about 9 wt % polymer, from about 3 wt % to about 8 wt % polymer, from about 4 wt % to about 7 wt % polymer, or from about 5 wt % to about 6 wt % polymer. In some embodiments, the composition may comprise from about 5 wt % to about 9 wt % polymer. Suitably, the composition may comprise from about 6 wt % to about 7 wt % polymer.

It is generally known to those skilled in polymer chemistry how to form polymers, including, but not limited to, acrylate and styrene monomers, having desired T_{g} values and acid numbers. For example, those skilled in the art would know how to prepare polymers (such as those used in film forming compositions and other liquid polymer emulsions) for application to a stone substrate so that polymers have the desired T_{g} and/or acid number. Moreover, and without being limited by theory, it is believed that film forming compositions having acrylate-styrene copolymers with higher amounts of styrene, when applied to a stone surface, form coatings that are more hydrophobic and have higher glossiness, but may be more difficult to level over substrates, have a higher overall T_{g}, and may be susceptible to color formation (e.g., yellowing). In contrast, film forming compositions having lower amounts of styrene (e.g., no styrene), when applied to a stone surface, may form coatings that are more hydrophilic (and thus may be more susceptible to being affected by water) and have lower glossiness, but are easier to level over the substrate, have a lower T_{g}, and may be less susceptible to color formation

### Waxes

Wax may refer to natural and/or synthetic low molecular weight polymeric compounds having melting point of less than or equal to about 170° C., and comprising one or more of long-chain alkanes, esters, polyesters and hydroxy esters of long-chain primary alcohols and fatty acids. Suitable examples of natural waxes include, but are not limited to, carnauba wax and beeswax (a mixture of ceroic acid and its homologs, myricin and some free melissic acid, nyricyl alcohol and uncombined ceryl alcohol), and paraffin waxes. Suitable examples of synthetic waxes include, but are not limited to, polymerized α-olefin waxes (e.g. polyethylene (PE), polypropylene (PP), poly 1-butene, etc.), PE-PP waxes, PEG-PPG (polyethylene glycol-polypropylene glycol) waxes, chemically modified waxes (e.g., saponified or esterified waxes), and substituted amide waxes (e.g., N,N-ethylene bis-stearamide, methylene bis-phenylstearmide, and amide waxes). For example, in some embodiments, the wax may be selected from the group consisting of a polyethylene wax, a polypropylene wax, a beeswax, a carnauba wax, a paraffin wax, and combinations thereof. In some embodiments, the wax may be selected from the group consisting of a polyethylene wax, a polypropylene wax, and combinations thereof.

The liquid film forming composition may comprise greater than 0.1 wt % wax, greater than about 0.2 wt % wax, greater than about 0.3 wt % wax, greater than about 0.4 wt % wax, greater than about 0.5 wt % wax, greater than about 0.6 wt % wax, greater than about 0.7 wt % wax, greater than about 0.8 wt % wax, greater than about 0.9 wt % wax, greater than about 1.0 wt % wax, greater than about 1.1 wt % wax, greater than about 1.2 wt % wax, greater than about 1.3 wt % wax, greater than about 1.4 wt % wax, greater than about 1.5 wt % wax, greater than about 1.6 wt % wax, greater than about 1.7 wt % wax, greater than about 1.8 wt % wax, greater than about 1.9 wt % wax, greater than about 2.0 wt % wax, greater than about 2.1 wt % wax, greater than about 2.2 wt % wax, greater than about 2.3 wt % wax, greater than about 2.4 wt % wax, greater than about 2.5 wt % wax, greater than about 2.6 wt % wax, greater than about 2.7 wt % wax, greater than about 2.8 wt % wax, greater than about 2.9 wt % wax, greater than about 3.0 wt % wax, greater than about 3.5 wt % wax, greater than about 4.0 wt % wax, or greater than about 4.5 wt % wax. The liquid film forming composition may comprise less than about 5.0 wt % wax, less than about 4.5 wt % wax, less than about 4.0 wt % wax, less than about 3.5 wt % wax, less than about 3.0 wt % wax, less than about 2.9 wt % wax, less than about 2.8 wt % wax, less than about 2.7 wt % wax, less than about 2.6 wt % wax, less than about 2.5 wt % wax, less than about 2.4 wt % wax, less than about 2.3 wt % wax, less than about 2.2 wt % wax, less than about 2.1 wt % wax, less than about 2.0 wt % wax, less than about 1.9 wt % wax, less than about 1.8 wt % wax, less than about 1.7 wt % wax, less than about 1.6 wt % wax, less than about 1.5 wt % wax, less than about 1.4 wt % wax, less than about 1.3 wt % wax, less than about 1.2 wt % wax, less than about 1.1 wt % wax, less than about 1.0 wt % wax, less than about 0.9 wt % wax, less than about 0.8 wt % wax, less than about 0.7 wt % wax, less than about 0.6 wt % wax, less than about 0.5 wt % wax, less than about 0.4 wt % wax, less than about 0.3 wt % wax, or less than about 0.2 wt % wax. The liquid film forming composition may comprise from about 0.1 wt % to about 5 wt % wax, such as from about 0.2 wt % to about 4.5 wt % wax, about 0.3 wt % to about 4 wt % wax, about 0.4 wt % to about 3.5 wt % wax, about 0.5 wt % to about 3 wt % wax, or about 0.6 wt % to about 2.5 wt % wax. For example, some compositions may comprise from about 0.5 wt % to about 3 wt % wax, whereas some compositions may comprise from about 0.5 wt % to about 2.5 wt % wax. In some embodiments, the composition may comprise a blend of waxes, such as a blend of from 0 wt % to about 5 wt % polyethylene wax and 0 wt % to about 5 wt % polypropylene wax. For example, some compositions may comprise a blend of about 1 wt % polyethylene wax and about 4 wt % polypropylene wax, about 2 wt % polyethylene wax and about 3 wt % polypropylene wax, about 3 wt % polyethylene wax and about 2 wt % polypropylene wax, or about 4 wt % polyethylene wax and about 1 wt % polypropylene wax. Other compositions may comprise a blend of about 0.1 wt % polyethylene wax and about 0.1 wt % polypropylene wax, about 0.3 wt % polyethylene wax and about 4.5 wt % polypropylene wax, or about 2 wt % polyethylene wax and about 0.5 wt % polypropylene wax, among various others.

Without being limited by theory, it is believe that the wax functions in the film forming compositions to provide coatings with at least one of the following: improved durability, improved black mark resistance, improved ability to be buffed to a gloss, improved film flexibility, and improved resilience. Moreover, it is believed that compositions having higher amounts of polypropylene wax generally may form coatings on stone substrates having higher coefficients of friction (COF), and having greater buffability, whereas compositions having higher amounts of polyethylene wax generally may form coatings on stone substrates with greater hardness, and with a lower coefficient of friction.

### Polymer/Resin/Wax Ratios and Total Solids

Typical floor coating compositions generally include a polymer, a resin and a wax in ratios (by weight) of about 70-90 parts polymer to about 1-5 parts resin to about 5-20 parts wax. In other words, the polymer/resin/wax ratios of these coating compositions are 70-90/1-5/5-20. These coating compositions also generally have total solids content of about 16-25 wt %. Due to the relatively high amount of total solids and, and the need for specialized polymers, resins, waxes and solvents, these floor coating compositions may be relatively expensive, and can be somewhat hazardous to handle. Moreover, these coating compositions are more specifically designed for application to relatively rough stone surfaces to form coatings having sufficiently desirable and/or necessary properties (i.e., sufficient glossiness, harness, coefficient of friction, durability, resistance to water, resistance to discoloration, etc.). A resin may be any substantially insoluble natural and/or synthetic organic compound having a high molecular weight and without a definite melting point. Resins are to be understood to include agents that modify the properties of coatings, such as to alter or enhance the at least one of leveling, hardness and stripability of a coating. Suitable examples of resins include, but are not limited to, alkali soluble rosin ester resins, and alkali-soluble low molecular weight copolymers of styrene and maleic acid anhydride.

It has been discovered that, in order to form coatings on stone floors that have been ground, polished and/or burnished (i.e., pretreated) according to the processes described above, it is unnecessary to use typical floor coating compositions having polymer/resin/wax ratios of about 70-9011-5/5-20, and total solids content of about 16-25 wt % in order to form coatings having desirable and/or necessary properties. Moreover, the description herein provides liquid film forming compositions that are optimal for use in forming coatings on stone surfaces that have been pretreated according to the processes described above, and demonstrates that other film forming compositions, when applied to substantially the same stone surfaces, form coatings having undesirable or unacceptable properties.

The film forming composition may have a mass ratio of polymer to wax of greater than about 1:1, greater than about 1.1:1, greater than about 1.2:1, greater than about 1.3:1, greater than about 1.4:1, greater than about 1.5:1, greater than about 1.6:1, greater than about 1.7:1, greater than about 1.8:1, greater than about 1.9:1, greater than about 2:1, greater than about 2.1:1, greater than about 2.2:1, greater than about 2.3:1, greater than about 2.4:1, greater than about 2.5:1, greater than about 2.6:1, greater than about 2.7:1, greater than about 2.8:1, greater than about 2.9:1, greater than about 3:1, greater than about 3.1:1, greater than about 3.2:1, greater than about 3.3:1, greater than about 3.4:1, greater than about 3.5:1, greater than about 4:1, or greater than about 4.5:1. The film forming composition may have a mass ratio of polymer to wax of less than about 5:1, less than about 4.5:1, less than about 4:1, less than about 3.5:1, less than about 3.4:1, less than about 3.3:1, less than about 3.2:1, less than about 3.1:1, less than about 3:1, less than about 2.9:1, less than about 2.8:1, less than about 2.7:1, less than about 2.6:1, less than about 2.5:1, less than about 2.4:1, less than about 2.3:1, less than about 2.2:1, less than about 2.1:1, less than about 2:1, less than about 1.9:1, less than about 1.8:1, less than about 1.7:1, less than about 1.6:1, less than about 1.5:1, less than about 1.4:1, less than about 1.3:1, less than about 1.2:1, or less than about 1.1:1.

Surprisingly, optimal liquid film forming compositions for use in coating stone floors pretreated according to the process described above have a polymer/wax mass ratio of from about 1:1 to about 5:1, such as a mass ratio of polymer to wax from about 2:1 to about 3.5:1, or a mass ratio of polymer to wax from about 2.5:1 to about 3.25:1. In some embodiments, the optimal mass ratio of polymer to wax may be about 2.8:1. It should be appreciated that some embodiments may have a resin content of 0 (i.e., that the composition does not include any resin), although in other compositions, resin optionally may be included.

Even more surprising was the discovery that liquid film forming compositions having less than about 15 percent total solids, and even those having total solids less than about 12.5 percent, were capable of forming coatings on pretreated stone floors with superior properties. Some embodiments have total solids content between about 8 and about 12 percent, such as about 10.25 percent. The total solids content may be less than about 15, about 14.5, about 14, about 13.5, about 13, about 12.5, about 12, about 11.5, about 11, or about 10.5. Stone coating compositions suitably do at least one of the following: protect the underlying stone substrate, impart an aesthetically appealing look (i.e., glossiness), and provide a safe walk way surface (i.e., sufficient coefficient of friction). Typical floor coating compositions have total solids contents of about 16-25%, and still must be applied in multiple coats (i.e. as little as three coats but as many as six or more coats) to provide a sufficient level of gloss, protection, and coefficient of friction. In the pretreatment process described above, the non-resilient stone floors (terrazzo, concrete, etc.) are honed to a point where some gloss already is imparted to the surface, such that there is less need for a lot of extra gloss from the coating. The compositions disclosed herein do not require more than about 15% solids to provide the desired glossiness while still surprisingly imparting sufficient protection and coefficient of friction to the surface. Because the liquid film forming compositions of described herein have lower total solids content, they are substantially less expensive.

In one embodiment, the composition may comprise a polymer and a wax having a melting point of less than or equal to about 170° C. and one or more of long-chain alkanes, esters, polyesters and hydroxy esters of long-chain primary alcohols and fatty acids. The composition may comprise from about 1 wt % to about 10 wt % polymer and/or about 0.1 wt % to about 5 wt % wax. The composition may have a mass ratio of polymer to wax of about 1:1 to about 5:1, and/or a total solids content of less than about 15 percent. The polymer may comprise at least one of an acrylate polymer, styrene-acrylate copolymer and a combination thereof. The wax may comprise at least one of a polyethylene wax, a polypropylene wax, a beeswax, a carnauba wax, a paraffin wax, and a combination thereof. The composition may be used in methods of polishing a stone surface. The method may comprise pre-treating the stone surface and applying the composition.

### Polyvalent Metal Ions

The liquid film forming compositions disclosed herein may include one or more polyvalent metal ions. In some embodiments, suitable polyvalent metals may be used as ionic crosslinking agents, as described in U.S. Pat. No. 3,308,078 and U.S. Pat. No. 4,517,330, each of which is hereby incorporated by reference in its entirety. Suitable polyvalent metal ions may include, but are not limited to, beryllium, cadmium, copper, calcium, magnesium, zinc, zirconium, barium, strontium, aluminum, bismuth, antimony, lead, cobalt, nickel, were the metal compound is typically a metal complex, a metal salt of an organic acid, or a metal chelate. Ammonia and amine complexes of these may be particularly useful because of their high solubility. Polyvalent metal ions may be added in quantities ranging from about 0.0005 wt % to about 1 wt % of the total composition.

A particularly suitable polyvalent metal ion is zinc. In some embodiments, additions of zinc to the liquid film forming composition may be made by additions of a solution of solubilized zinc oxide (i.e., zinc ammonium carbonate, the solution equates to adding 0.15 g ZnOIg solution). In some embodiments, zinc additions may be based on a molar ratio of active ZnO moles to the total moles of the carboxylic acid (“COOH”) functionality of the polymer.

### Other Additives

The compositions described herein may include one or more other additives selected from the group consisting of plasticizers, pH adjusters, wetting agents, defoamers, coalescing agents, preservatives, dyes, pigments, fragrances, optical components, nanoparticles, embedded particles, and combinations thereof.

Plasticizers

Plasticizers provide flexibility and assist in film formation, and generally remain in the film after curing. Suitable plasticizers may include, but are not limited to, phosphates (e.g., tributoxy ethyl phosphate, triphenyl phosphate, etc.), ester alcohols (e.g., 2,2,4-trimethyl-1,3-pentanediol isobutyrate, 2,2,4-trimethyl-1,3-pentanediol diisobutyrate, etc.), phthalates (e.g., dibutyl phthalate, butyl benzyl phthalate, diocyl phthalate, diisooctyl phthalate, etc.), pyrrolidones (e.g., N-methyl pyrrolidone, N-ethyl pyrrolidone, etc.), benzoate esters (e.g., diethylene glycol dibenzoate, triethylene glycol dibenzoate, dipropylene glycol dibenzoate), caprolactams, and many other plasticizers known to those skilled in the art. In some embodiments, the plasticizer may comprise from about 2-12 wt % of the total film former composition, such as about 3-10 wt %, or 4-8 wt %, among others. Some embodiments may have between about 4-5 wt % plasticizer, such as about 4.8 wt %.

Coalescing Agents

The film forming compositions described herein further may include one or more coalescing agents including, but not limited to, glycol ethers, such as diethylene glycol methyl ether, diethylene glycol ethyl ether, diethylene glycol butyl ether, diethylene glycol hexyl ether, ethylene glycol hexyl ether, ethylene glycol phenyl ether, ethylene glycol 2-ethylhexyl ether, and dipropylene glycol n-propyl ether, dipropylene glycol n-butyl ether, propylene glycol phenyl ether, etc. The coalescing agents may comprise up to about 10 wt % of the total liquid film forming composition, such as up to about 0.1 wt %, 0.2 wt %, 0.4 wt %, 0.6 wt %, 0.8 wt %, 1 wt %, 2 wt %, 3 wt %, 4 wt %, 5 wt %, 6 wt %, 7 wt %, 8 wt %, 9 wt %, or 10 wt % of the total composition.

Defoamers

Suitable defoamers may include, but are not limited to organic polymer, polysiloxane, silicone, or acetylene-based defoamers. The defoamer may comprise up to about 2 wt % of the total liquid film forming composition. In some embodiments, the defoamer may include, without limitation, TEGO® FOAMEX 822 (Evonik Tego Chemie GmbH, Essen, Germany).

Wetting Agents

Some embodiments of the liquid film forming composition may include a wetting agent. Wetting agents may include, for example, tributoxyethyl phosphate, fluorochemical surfactants, such as ethoxylated non-ionic fluorochemicals, anionic fluorochemical surfactants based on carboxylic acid, phosphate, sulfate, or sulfonate functionality, alcohol ethoxylate surfactants, organophosphate surfactants, organo-silicones, fluorine containing emulsion polymers or fluorine containing aqueous polymer dispersions, or others known to those of skill in the art. Wetting agents may comprise up to about 10 wt % of the total liquid film forming composition, such as up to about 0.1 wt %, 0.2 wt %, 0.4 wt %, 0.6 wt %, 0.8 wt %, 1 wt %, 2 wt %, 3 wt %, 4 wt %, 5 wt %, 6 wt %, 7 wt %, 8 wt %, 9 wt %, or 10 wt % of the total composition.

In some embodiments, the wetting agent may include, without limitation, CAPSTONE™ FS-60, CAPSTONE™ FS-63 (DuPont Chemical and Fluoroproducts, Wilmington, Del.), CHEMGUARD™ S-761P (Chemguard, Mansfield, Tex.).

pH Adjusters

pH adjusters may be used to adjust the pH of the maintenance layer composition or the adhesive layer composition. For example, ammonia, ammonium hydroxide, amines, hydroxides, silicates, phosphates and other additives known to those skilled in the art may be used to adjust the pH of the system if deemed necessary in an amount up to about 2 wt % of the liquid film forming composition.

Preservatives, Dyes, Pigments, Fragrances, and Other Embedded Particles

Various preservatives, dyes, pigments, and fragrances also may be included in some compositions described herein. These types of additives are well-known to those skilled in the art. A suitable preservative may include formaldehyde, among numerous others. Suitable dyes may include, for example, FD&C blue #1 (Keystone, Chicago, Ill.), and anatase titanium dioxide AT-1 white dye (Hankok Titanium Industry, Seoul, Korea) Suitable pigments may include some organic pigments, such as, for example, azo metal complexes and dioxazine, and inorganic pigments, such as, for example, carbon black, titanium dioxide and azurite. Suitable fragrances may include Robertet fragrances, including Robertet 98M.

Additionally, nanoparticles, embedded particles, and other additives may be included in some embodiments. Suitable nanoparticles may be those with diameters of 1-100 nanometer and may include, for example, carbon, ceramics, glass-ceramics, polymers, and nano-sized quantum dots in the shape of a sphere, a core-shell sphere, or a tube. These are typically used in a range of about 0.05 to about 10 wt % of the liquid film forming composition. Suitable embedded particles may include glass, ceramics, and highly cross-linked hard polymer. These are typically used in a range of about 0.05 to about 5 wt % of the liquid film forming composition. Embedded particles may have a size of about 51 to about 500 microns.

### Water

The balance of the composition may be water. The liquid film forming composition may comprise greater than about 50 wt % water, greater than about 55 wt % water, greater than about 60 wt % water, greater than about 65 wt % water, greater than about 70 wt % water, greater than about 75 wt % water, greater than about 80 wt % water, greater than about 85 wt % water, or greater than about 90 wt % water. The liquid film forming composition may comprise less than about 95 wt % water, less than about 90 wt % water, less than about 85 wt % water, less than about 80 wt % water, less than about 75 wt % water, or less than about 70 wt % water. The liquid film forming composition may comprise between about 50 wt % water and about 95 wt % water.

### Method of Making Liquid Film Forming Compositions

Liquid film forming compositions may be prepared by standard mixing procedures known to one of skill in the art. Emulsions of polymers and waxes may be prepared to form stock emulsions, which in turn may be mixed in a variety of ways.

### Properties of Coatings and Coated Floor Surfaces

The compositions disclosed herein, when applied to pretreated stone floors according to the process described above, form coatings and coated floor surfaces having superior properties.

In some embodiments, the liquid film forming composition may be applied at a rate of 1,800 sq. ft/gal to about 3,000 sq. ft/gal, which can result in coating thicknesses of about 0.26485 mil or 2.12 grams/sq. inch to about 0.0583 mil or 1.27 grams/sq. inch using traditional mop and bucket methods of application or other suitable applicators.

### Hardness

As described in more detail in the examples, the hardness of coatings formed when various film forming compositions were applied to pretreated stone substrates were measured according to the König hardness scale. Exemplary compositions form coatings having hardnesses between about 30 and about 70 on the König hardness scale one day after application. The hardness may be greater than about 30, about 35, about 40, or about 45. The hardness may be less than about 70, less than about 65, less than about 60, or less than about 55. As discussed in the examples, coatings having hardnesses greater than about 70 one day after application were more susceptible to discoloration (e.g., yellowing). Without being limited to theory, this discoloration may occur due to the harder surfaces being more susceptible to scratching (thus allowing for discoloring contaminants to find purchase in the coating), and less amenable to cleaning and/or burnishing. Film forming compositions having optimal polymer/resin/wax ratios (such as mass ratios of polymer to wax from about 2:1 to about 3:1) and having hardnesses between about 30 and about 70 on the König hardness scale one day after application to a pretreated stone floor, were found to resist discoloration. Moreover, these coatings were found to have optimal glossiness and coefficients of friction. Suitably, the coating may have a hardness between about 35 and about 50 on the König hardness scale one day after application, such as a hardness of about 42 on the König hardness scale one day after application.

### Coefficients of Friction

The film former compositions according to the present invention all were found to form coatings on stone floors pretreated according to the methods disclosed above having a static coefficient of friction of 0.5 or greater as measured by the ASTM D2047 standard test method. The ASTM D2047 standard test method uses a James machine to measure the static coefficient of friction of a polish-coated flooring surface, and requires that compliant floors have a coefficient of friction greater than 0.5. More particularly, film former compositions having mass ratios of polymer to wax between about 2.5:1 and about 3.25:1 formed coatings having coefficients of friction greater than 0.5. In contrast, other flooring compositions having alternative mass ratios of polymer to wax, when applied to stone floors pretreated according to the methods disclosed herein, did not have suitable coefficients of friction.

### Glossiness

Film forming compositions according to the invention were found to form coatings on stone floors pretreated according to the methods disclosed above having exceptional glossiness as measured by the ASTM D2457 standard test method or any equivalent method known to one of skill in the art. Some compositions, when applied to an uncoated stone floor surface having a glossiness from about 5 to about 45 at 20 degrees, from about 20 to about 75 at 60 degrees, and from about 40 to about 95 at 85 degrees, formed a coating on the surface, where the coated surface had a glossiness from about 20 to about 75 at 20 degrees, from about 50 to about 90 at 60 degrees, and from about 55 to about 100 at 85 degrees. For example, when some film former compositions were applied to an uncoated concrete surface having a glossiness from about 5 to about 20 at 20 degrees, from about 20 to about 40 at 60 degrees, and from about 40 to about 55 at 85 degrees, the coated floor surface had a glossiness from about 20 to about 40 at 20 degrees, from about 50 to about 65 at 60 degrees, and from about 55 to about 80 at 85 degrees. When applied to an uncoated marble surface having a glossiness from about 15 to about 45 at 20 degrees, from about 50 to about 75 at 60 degrees, and from about 80 to about 95 at 85 degrees, the coated floor surface had a glossiness from about 40 to about 80 at 20 degrees, from about 65 to about 90 at 60 degrees, and from about 85 to about 100 at 85 degrees. When applied to an uncoated terrazzo surface having a glossiness from about 10 to about 20 at 20 degrees, from about 35 to about 50 at 60 degrees, and from about 50 to about 65 at 85 degrees, and the coated floor surface had a glossiness from about 35 to about 50 at 20 degrees, from about 55 to about 75 at 60 degrees, and from about 65 to about 80 at 85 degrees. When applied to an uncoated granite surface having a glossiness from about from about 5 to about 20 at 20 degrees, from about 20 to about 45 at 60 degrees, and from about 60 to about 85 at 85 degrees, and the coated floor surface had a glossiness from about 30 to about 70 at 20 degrees, from about 60 to about 85 at 60 degrees, and from about 75 to about 100 at 85 degrees.

### Anti-Yellowing

Film forming compositions according to the invention may be found to form coatings on stone floors pretreated according to the methods disclosed above having exceptional color stable properties. The compositions may be measured according to a coating color stability test that measures the CIELAB L*, a* and b* values of different coatings on stone floors over different periods of time (e.g. about 30 days with foot traffic). CIELAB is one of several International Commission on Illumination (CIE) color spaces that defines the range of colors visible to the human eye, and should be readily known to those of skill in the art. The coordinate L* stands for lightness, a* represents where the color is on the redness-greeness axis and b* stands for the color's position on the yellowness-blueness axis. The subject matter found in http://www.specialchem4coatings.com/tc/color/index.aspx?id=cielab is hereby fully incorporated by reference. A color is defined as pure white when L*=100, a*=0 and b*=0. A color is defined as absolute black when L*=0, a*=0 and b*=0. The CIELAB values of color stable coatings should remain relatively constant over long periods of time. The coatings are expected to show excellent color stability according to this test.

Some of the coatings in the present invention showed excellent color stability when exposed to foot traffic for extended periods of time based on qualitative analysis.

Various additional features and advantages of liquid film forming composition are set forth in the following examples.

### EXAMPLES

BYK®-024 is a defoamer containing foam-destroying polysiloxanes and hydrophobic solids in polyglycol. Available commercially from BYK Additives & Instruments, Wallingford, Conn.

Proxel™ GXL is an antimicrobial preservative. Available commercially from Arch Chemicals Inc., Smyrna, Ga.

Capstone™ FS-50 and FS-60 are fluorosurfactants. Available commercially from DuPont Chemical and Fluoroproducts, Wilmington, Del.

Silfoam® is a self-dispersing antifoaming agent. Available from Wacker Chemie AG, Burghausen, Germany.

Abex® JKB and 2005 are surfactants. Available from Alcolac, Inc., Baltimore, Md.

Acticide® MBS is a biocide. Available from Thor GmbH, Speyer, Germany.

Fizul MD 318 is a disodium oleamido MIPA sulfosuccinate. Available from Finetex, Inc.

Gemtex 691-40 is a sodium dicyclohexyl sulfosuccinate. Available from Finetex, Inc.

Kathon™ LX is a microbiocide. Available from The Dow Chemical Company, Midland, Mich.

Benzoflex™ 2088 is a high solvating plasticizer. Available commercially from Eastman Chemical Company, Kingsport, Tenn.

The polymers and co-polymers of the Examples comprised one or more of the following monomer units: styrene, methyl methacrylate, butyl acrylate, and methacrylic acid.

### Example 1

### Liquid Film Forming Compositions

The liquid film forming compositions 1-5 were prepared by standard mixing procedures, with the polymer, polypropylene wax and polyethylene wax being prepared as emulsions. Amounts are given in wt %.

TABLE 1
Liquid Film Forming Composition 1

| Component | Amount |
|---|---|
| Water | 84.60 |
| Styrene-acrylate Copolymer (T_{g} = 68° C., acid | 6.43 |
| number = 67, percent styrene = 25.5%) | |
| Polyethylene Wax | 1.57 |
| Polypropylene Wax | 0.65 |
| Diethylene Glycol Ethyl Ether | 2.5 |
| Dipropylene Glycol Methyl Ether | 0.5 |
| Propylene Glycol Phenyl Ether | 0.5 |
| Tributoxyethyl Phosphate | 0.5 |
| Zinc oxide, ammonium carbonate, ammonia | 1.15 |
| solution (35%) | |
| Capstone ™ FS-60 | 0.06 |
| Silfoam ® SD 168 | 0.01 |
| Ammonium Persulfate | 0.04 |
| Ammonium Hydroxide (30%) | 0.03 |
| Potassium Hydroxide (45%) | 0.16 |
| Formaldehyde (37%) | 0.02 |
| Sodium Hydrogen Sulfite (38%) | 0.04 |
| C₁₂₋₁₅ alcohol ethoxylate (9 EO) | 0.59 |
| Abex ® JKB (30%) | 0.43 |
| Gemtex 691-40 (40%) | 0.18 |
| Kathon ™ LX (14%) | 0.06 |

TABLE 2
Liquid Film Forming Composition 2

| Component | Amount |
|---|---|
| Water | 85.12 |
| Styrene-acrylate Copolymer (Tg = 68° C., acid | 6.43 |
| number = 67, percent styrene = 25.5%) | |
| Polyethylene Wax | 1.57 |
| Polypropylene Wax | 0.64 |
| Diethylene Glycol Ethyl Ether | 2.5 |
| Propylene Glycol Phenyl Ether | 0.5 |
| Tributoxyethyl Phosphate | 0.5 |
| Zinc oxide, ammonium carbonate, ammonia | 1.15 |
| solution (35%) | |
| Capstone ™ FS-60 | 0.06 |
| Silfoam ® SD 168 | 0.01 |
| Ammonium Persulfate | 0.04 |
| Ammonium Hydroxide (30%) | 0.03 |
| Potassium Hydroxide (45%) | 0.16 |
| Formaldehyde (37%) | 0.02 |
| Sodium Hydrogen Sulfite (38%) | 0.04 |
| C₁₂₋₁₅ alcohol ethoxylate (9 EO) | 0.58 |
| Abex ® JKB (30%) | 0.43 |
| Gemtex 691-40 (40%) | 0.18 |
| Kathon ™ LX (14%) | 0.06 |

TABLE 3
Liquid Film Forming Composition 3

| Component | Amount |
|---|---|
| Water | 85.06 |
| Styrene-acrylate Copolymer (Tg = 68° C., acid | 6.72 |
| number = 67, percent styrene = 25.5%) | |
| Polyethylene Wax | 0.90 |
| Polypropylene Wax | 0.84 |
| Diethylene Glycol Ethyl Ether | 1.25 |
| Propylene Glycol | 1.25 |
| Benzoflex ™ 2088 | 0.44 |
| Zinc oxide, ammonium carbonate, ammonia | 1.31 |
| solution (35%) | |
| Capstone ™ FS-50 | 0.06 |
| Tergitol 15-S-40 | 0.71 |
| Proxel ™ GXL | 0.02 |
| Silfoam ® SD 168 | 0.01 |
| Ammonium Persulfate | 0.04 |
| Ammonium Hydroxide (30%) | 0.03 |
| Potassium Hydroxide (45%) | 0.17 |
| Formaldehyde (37%) | 0.01 |
| Sodium Hydrogen Sulfite (38%) | 0.03 |
| C₁₂₋₁₅ alcohol ethoxylate (9 EO) | 0.48 |
| Abex ® JKB (30%) | 0.45 |
| Gemtex 691-40 (40%) | 0.19 |
| Kathon ™ LX (14%) | 0.06 |

TABLE 4
Liquid Film Forming Composition 4

| Component | Amount |
|---|---|
| Water | 85.23 |
| Acrylate Polymer (Tg = 76° C., acid number = | 6.44 |
| 69, percent styrene = 0) | |
| Polyethylene Wax | 1.59 |
| Polypropylene Wax | 0.65 |
| Diethylene Glycol Ethyl Ether | 2.5 |
| Dipropylene Glycol Methyl Ether | 0.5 |
| Propylene Glycol Phenyl Ether | 0.5 |
| Tributoxyethyl Phosphate | 0.5 |
| Zinc oxide, ammonium carbonate, ammonia | 0.86 |
| solution (35%) | |
| Capstone ™ FS-60 | 0.06 |
| BYK ®-024 | 0.01 |
| Ammonium Persulfate | 0.04 |
| Potassium Hydroxide (45%) | 0.16 |
| Formaldehyde (37%) | 0.02 |
| Sodium Hydrogen Sulfite (38%) | 0.05 |
| C₁₂₋₁₅ alcohol ethoxylate (9 EO) | 0.59 |
| Abex ® 2005 (30%) | 0.21 |
| Tergitol 15-S-12 | 0.10 |

TABLE 5
Liquid Film Forming Composition 5

| Component | Amount |
|---|---|
| Water | 84.69 |
| Styrene-acrylate Copolymer (Tg = 62° C., acid | 6.76 |
| number = 35, percent styrene = 10.2%) | |
| Polyethylene Wax | 1.59 |
| Polypropylene Wax | 0.65 |
| Diethylene Glycol Ethyl Ether | 2.5 |
| Dipropylene Glycol Methyl Ether | 0.5 |
| Propylene Glycol Phenyl Ether | 0.5 |
| Tributoxyethyl Phosphate | 0.5 |
| Zinc oxide, ammonium carbonate, ammonia | 0.46 |
| solution (35%) | |
| Capstone ™ FS-60 | 0.06 |
| BYK ®-024 | 0.01 |
| Ammonium Hydroxide | 0.04 |
| Potassium Hydroxide (45%) | 0.16 |
| Formaldehyde (37%) | 0.02 |
| Sodium Hydrogen Sulfite (38%) | 0.05 |
| C₁₂₋₁₅ alcohol ethoxylate (9 EO) | 0.59 |
| Sodium Formaldehyde Sulfoxylate | 0.02 |
| Acticide MBS (2.7%) | 0.10 |
| Fizul MD 318 | 0.77 |

### Example 2

### Coated Floor Surfaces and Gloss Measurements

Liquid film forming composition 1 was applied to terrazzo, concrete, marble, and granite floor surfaces that had been pretreated according to the methods described herein, whereupon the compositions dried to form a coating. The glossiness of the coated surfaces was measured at 20, 60 and 85 degrees prior to and after coating, and values are reported in Gloss Units (GU).

TABLE 6
Coated Terrazzo Floor Surfaces

| Floor Surface | | 20 deg. | 60 deg. | 85 deg. |
|---|---|---|---|---|
| Terrazzo Floor Surface 1 | Uncoated | 17 | 40 | 54 |
| | Coated | 40 | 60 | 66 |
| Terrazzo Floor Surface 2 | Uncoated | 11 | 37 | 58 |
| | Coated | 46 | 69 | 73 |
| Terrazzo Floor Surface 3 | Uncoated | 17 | 47 | 63 |
| | Coated | 45 | 68 | 75 |

TABLE 7
Coated Concrete Floor Surfaces

| Floor Surface | | 20 deg. | 60 deg. | 85 deg. |
|---|---|---|---|---|
| Concrete Floor Surface 1 | Uncoated | 6 | 22 | 44 |
| | Coated | 24 | 55 | 75 |
| Concrete Floor Surface 2 | Uncoated | 15 | 39 | 52 |
| | Coated | 37 | 53 | 56 |

TABLE 8
Coated Marble Floor Surfaces

| Floor Surface | | 20 deg. | 60 deg. | 85 deg. |
|---|---|---|---|---|
| Marble Floor Surface 1 | Uncoated | 32 | 68 | 92 |
| | Coated | 64 | 86 | 98 |
| Marble Floor Surface 2 | Uncoated | 19 | 59 | 89 |
| | Coated | 48 | 79 | 100 |
| Marble Floor Surface 3 | Uncoated | 20 | 56 | 89 |
| | Coated | 43 | 72 | 92 |
| Marble Floor Surface 4 | Uncoated | 30 | 60 | 85 |
| | Coated | 42 | 74 | 97 |
| Marble Floor Surface 5 | Uncoated | 38 | 70 | 85 |
| | Coated | 73 | 84 | 87 |
| Marble Floor Surface 6 | Uncoated | 44 | 75 | 83 |
| | Coated | 75 | 85 | 89 |

TABLE 9
Coated Granite Floor Surfaces

| Floor Surface | | 20 deg. | 60 deg. | 85 deg. |
|---|---|---|---|---|
| Granite Floor Surface 1 | Uncoated | 13 | 41 | 83 |
| | Coated | 56 | 80 | 95 |
| Granite Floor Surface 2 | Uncoated | 8 | 33 | 74 |
| | Coated | 42 | 69 | 89 |
| Granite Floor Surface 3 | Uncoated | 15 | 39 | 81 |
| | Coated | 64 | 83 | 96 |
| Granite Floor Surface 4 | Uncoated | 6 | 24 | 65 |
| | Coated | 32 | 61 | 81 |

As shown above, application of the liquid film forming composition 1 to pretreated terrazzo, concrete, marble and granite improved gloss measurements. Typically, compositions used to coat stone surfaces contain higher solids content and resins. It was found that the coatings disclosed above, such as liquid film forming composition 1, which had substantially lower solids content and did not include resins, may be used on substrates pretreated according to the methods described herein to achieve a high-gloss finish, as indicated in Tables 6-9.

### Example 3

### Coefficient of Friction

Liquid film forming composition 1 and WiWax™, a coating composition having a polymer-to-wax ratio of about 6.5 and available commercially from Diversey, Inc., Sturtevant, Wis., each were separately applied to stone surfaces that had been pretreated according to the methods described herein, whereupon the compositions dried to form coatings. The coefficient of friction of the coated surfaces were measured with a Brungraber Mark I tester. The coated terrazzo floor surface prepared with liquid film forming composition 1 achieved a coefficient of friction greater than 0.5. In contrast, the coated terrazzo floor surface prepared with WiWax™ achieved a coefficient of friction lower than 0.5. These results support the conclusion that the ratio of polymer to wax in a film forming composition affects the coefficient of friction of coatings formed by the composition. Moreover, these results demonstrate that some film forming compositions, such as the WiWax™ composition, with a polymer-to-wax ratio of about 6.5, when applied to stone floors that have been pretreated according to the methods described herein, form coatings having coefficients of friction lower than 0.5.

### Example 4

### Hardness and Yellowing Resistance

Liquid film forming compositions 1, 4, and 5 and Scotchgard™ Stone Floor Protector, available commercially from 3M™, St. Paul, Minn., each were applied to stone surfaces that had been pretreated according to the methods described herein, whereupon the compositions dried to form coatings. The hardness of each coating was measured one day after the coating was formed according to the König hardness test. Hardness values are reported in number of pendulum oscillations.

TABLE 10
Hardness

| Coating | Hardness |
|---|---|
| Liquid Film Forming Composition 1 | 45.25 |
| Liquid Film Forming Composition 4 | 66 |
| Liquid Film Forming Composition 5 | 36.75 |
| Scotchgard ™ Stone Floor Protector | 87.25 |

Coatings produced from the liquid film forming compositions of the present invention exhibit lower hardness one day after the coating was formed than coatings produced from Scotchgard™ Stone Floor Protector. It is generally believed that floor surfaces that are too hard may be more susceptible to scratching and less amenable to cleaning and burnishing, and as a result, may be more susceptible to discoloration caused by particulate matter becoming engrained in the scratches.

Liquid film forming composition 1 and Scotchgard™ Stone Floor Protector each were applied to terrazzo floor surfaces pretreated according to the methods described herein, whereupon the compositions dried to form coatings. It was observed that, three months after application, the coating prepared with liquid film forming composition 1 exhibited significantly less yellowing than the coating prepared with Scotchgard™ Stone Floor Protector. It is believed that the lower initial hardness of the coating prepared with liquid film forming composition 1 allows the coating to avoid fine scratches, within which particulate matter may become engrained, thereby causing eventual yellowing. These results support the conclusion that the hardness of the coating formed by film forming composition 1 is more preferred than the hardness of the coating formed with the Scotchgard™ Stone Floor Protector. Moreover, the hardness of the coating prepared with liquid film forming composition 1 also was observed to be sufficiently high to resist damage from foot traffic.

### Surface Preparation and Finishing

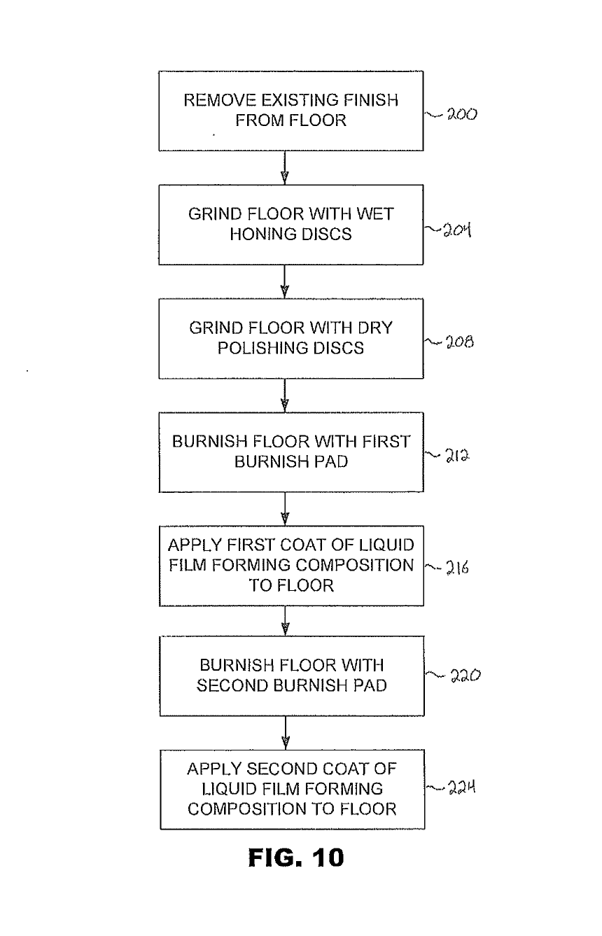

FIG. 10 is a flow chart illustrating a method or process of preparing the surface 14 using the system described above. At step 200, the process begins by removing or stripping any existing floor finish (e.g., wax, polish, etc.) from the floor. The existing floor finish may be removed with, for example, a chemical stripper. The process at step 200 can be omitted if the surface 14 is new or if a finish has not previously been applied to the floor.

With the surface 14 adequately stripped or devoid of floor finish, the surface 14 is ground or abraded at step 204 using the swing machine 16 (or other suitable machine, as described above), the pad 24, and the honing discs 28, and water. The second burnish pad 24 is coupled to the swing machine 16, and three or four honing discs 28 are attached to the burnish pad 24. The quantity of honing discs 28 that are attached to the burnish pad depends in part on the type of surface 14 that is being prepared for floor finish. The honing discs 28 may be attached to the burnish pad 24 before or after the pad 24 is coupled to the prep machine 16.

Before grinding the surface 14, clean water should be applied so that the surface 14 remains wet during the process of grinding the surface at step 204. With the surface 14 adequately wetted, the swing machine 16 is maneuvered over the wet floor a predetermined number of passes (e.g., 10 to 12 passes) at, for example, a rate of two to four square-feet per minute. The number of passes for a particular floor composition may be set beforehand or may be adjusted during performance of the honing 204 to achieve a desired gloss. Slurry generated as a result of grinding the wet surface 14 can be removed using, for example, an auto scrubber, such as one of the TASKI swingo auto scrubber driers manufactured by Diversey. In some embodiments, the surface 14 may be further cleaned after step 204 with a floor cleaner and the second burnish pad 24 without the honing discs 28 to help remove any residual slurry. When the surface 14 comprises marble or granite, it may not be necessary to grind the surface 14 with the honing discs 28 unless the surface 14 is severely damaged.

After abrading the surface 14 at step 204, the surface 14 is allowed to dry. When the surface 14 is adequately dry, surface 14 is polished at step 208 using the swing machine 16. The second burnish pad 24 is rotatably attached to the swing machine 16 and the polishing discs 64 are attached to the pad 24 (e.g., before or after attachment of the pad 24 to the swing machine 16). Depending on the surface 14 being polished, three or four polishing discs 64 can be attached to the burnish pad 24 to achieve the desired level of polish. The swing machine 16 is maneuvered over the dry floor a predetermined number of passes (e.g., at least 4 or 6 passes) at a rate of ten to twelve square-feet per minute. The number of passes for the surface 14 may be set beforehand or may be adjusted during performance of the polishing step 208 to achieve a desired gloss.

By keeping the surface 14 dry during step 208, the time needed to polish the surface 14 is minimized and speeds up subsequent cleaning, allowing an operator to proceed to the next step in the process more quickly than when the surface 14 is wetted during polishing. Also, the dry polishing at step 208 produces a gloss on the surface 14 that is visible to the operator or a bystander as the surface 14 is being polished. Dust created during the polishing step 208 can also be removed using, for example, an auto scrubber. In some embodiments, the surface 14 may again be cleaned after the polishing step 208 with a surface 14 cleaner and the second burnish pad 24 without the polishing discs 64.

After the surface 14 has been honed at step 204 and polished at step 208, the surface 14 is burnished with the first burnish pad 20 at step 212. During this step, the burnish pad 20 is coupled to the burnisher 18. In some embodiments, the burnisher 18 may rotate the pad 20 at at least 2000 revolutions per minute. In other embodiments, the burnisher 18 may rotate the pad 20 at approximately 2000 to 3500 revolutions per minute. As noted above, the first burnish pad 20 can have a higher grit than the polishing discs 64, but the pad 20 can have a lower grit than the second burnish pad 24. The burnisher 18 is passed over the surface 14 a number of passes (e.g., two passes in each direction) to complete polishing of the surface 14. After this burnishing step 212, the surface 14 may be dust mopped to remove any residual dust.

At step 216 a first coat of liquid film forming composition is applied to the surface 14 using the floor finish application tool 100. To apply the liquid film forming composition to the surface 14, a supply of the composition is loaded into a reservoir 104 on the floor finish application tool 100. Using the application tool 100, a thin, even coat of the composition is applied to the surface 14 at a rate (e.g., 2500 to 3500 square-feet per gallon) that evenly distributes the composition. After the first coat is applied, the surface 14 should be allowed to dry for a predetermined time period (e.g., at least about 30 minutes) to create a solid film or coating on the surface 14.

After the first coat of liquid film forming composition has dried, the surface 14 is burnished with the second burnish pad 24 at step 220. During this step, the burnish pad 24 is coupled to the burnisher 18 without the discs 28, 64. In some embodiments, the burnisher 18 may rotate the pad 24 at at least 2000 revolutions per minute. In other embodiments, the burnisher 18 may rotate the pad 24 at approximately 2000 to 3500 revolutions per minute. In some preferred embodiments, the second burnish pad 24 provides a higher grit than the polishing discs 64 and the first burnish pad 20. The burnisher 18 is maneuvered over the surface 14 a predetermined number of passes (e.g., at least two passes in each direction) to enhance gloss and prepare the surface 14 for a second coat of liquid film forming composition. After this burnishing step 220, the surface 14 may be dust mopped to remove any residual dust.

At step 224 the second coat of liquid film forming composition is applied to the surface 14 in the same manner as the first coat of liquid film forming composition described at step 216. In some situations, such as for granite or marble surfaces, only one coat of the composition may be needed. After the second coat is applied, the surface 14 should dry for about 15 to 30 minutes to create a solid film or coating on the surface 14. If desired, the surface 14 may be burnished an additional time at the end of the process with the burnisher 18 and the second burnish pad 24. Additional burnishing can enhance the gloss of the surface 14.

The system and process described with regard to FIGS. 1-10 simplifies floor maintenance by reducing the amount of labor and time required to clean, rejuvenate, and restore the surface 14. For example, aside from regular cleaning with a mop and/or water, regular burnishing with the second burnish pad 24 may only need to be performed, for example, twice per week. In addition, periodic rejuvenation with a cleaner and the second burnish pad 24 may only need to be performed, for example, once every four months. Furthermore, periodic restoration with a cleaner, the first burnish pad 20, and reapplication of the liquid film forming composition may only need to be performed, for example, less than once per year.

The system and process described above produces a relatively high gloss (measured using a conventional glossmeter) on the surface 14. For example, after polishing and burnishing a terrazzo surface (i.e., after step 212), the surface can have a gloss at or above 10 at 20 degrees, a gloss at or above 35 at 60 degrees, and a gloss at or above 50 at 85 degrees. In some embodiments, the gloss of the terrazzo surface may be between about 10 and 20 at 20 degrees, between about 35 and 50 at 60 degrees, and between about 50 and 65 at 85 degrees after polishing and burnishing. Furthermore, after applying the liquid film forming composition, the surface 14 can have a gloss at or above 35 at 20 degrees, a gloss at or above 55 at 60 degrees, and a gloss at or above 65 at 85 degrees. In some embodiments, the gloss of the terrazzo surface may be between about 35 and 50 at 20 degrees, between about 55 and 70 at 60 degrees, and between about 65 and 75 at 85 degrees after applying the composition.

After polishing and burnishing a concrete surface (i.e., after step 212), the surface can have a gloss at or above 5 at 20 degrees, a gloss at or above 20 at 60 degrees, and a gloss at or above 40 at 85 degrees. In some embodiments, the gloss of the concrete surface may be between about 5 and 20 at 20 degrees, between about 20 and 40 at 60 degrees, and between about 40 and 55 at 85 degrees. Furthermore, after applying the liquid film forming composition, the surface can have a gloss at or above 20 at 20 degrees, a gloss at or above 50 at 60 degrees, and a gloss at or above 55 at 85 degrees. In some embodiments, the gloss of the concrete surface may be between about 20 and 40 at 20 degrees, between about 50 and 65 at 60 degrees, and between about 55 and 75 at 85 degrees after applying the composition.

After polishing and burnishing a marble surface (i.e., after step 212), the surface can have a gloss at or above 15 at 20 degrees, a gloss at or above 40 at 60 degrees, and a gloss at or above 80 at 85 degrees. In some embodiments, the gloss of the marble surface may be between about 15 and 45 at 20 degrees, between about 40 and 75 at 60 degrees, and between about 80 and 95 at 85 degrees. Furthermore, after applying the liquid film forming composition, the surface can have a gloss at or above 40 at 20 degrees, a gloss at or above 70 at 60 degrees, and a gloss at or above 85 at 85 degrees. In some embodiments, the gloss of the marble surface may be between about 40 and 75 at 20 degrees, between about 70 and 90 at 60 degrees, and between about 85 and 100 at 85 degrees after applying the composition.

After polishing and burnishing a granite surface (i.e., after step 212), the surface can have a gloss at or above 5 at 20 degrees, a gloss at or above 20 at 60 degrees, and a gloss at or above 65 at 85 degrees. In some embodiments, the gloss of the granite surface may be between about 5 and 20 at 20 degrees, between about 20 and 45 at 60 degrees, and between about 65 and 85 at 85 degrees. Furthermore, after applying the liquid film forming composition, the surface can have a gloss at or above 30 at 20 degrees, a gloss at or above 60 at 60 degrees, and a gloss at or above 80 at 85 degrees. In some embodiments, the gloss of the granite surface may be between about 30 and 65 at 20 degrees, between about 60 and 85 at 60 degrees, and between about 80 and 100 at 85 degrees after applying the composition.

Various features and advantages of the invention are set forth in the following claims.

1-61. (canceled)

62. A method of polishing a stone surface, the method comprising:
(A) pre-treating the stone surface by burnishing the stone surface to form a pretreated stone surface;
(B) applying a liquid film forming composition to the stone surface, the liquid film forming composition comprising from about 1 wt % to about 10 wt % polymer and about 0.1 wt % to about 5 wt % wax, the polymer comprising at least one of an acrylate polymer, a styrene-acrylate copolymer and a combination thereof, and
(C) drying the liquid film forming composition on the stone surface to form a coating having a thickness of from about 0.05 mil to about 027 mil.

63. The method according to claim 62, further comprising removing an existing finish from the stone surface before pre-treating the stone surface.

64. The method according to claim 62, wherein the pre-treating further comprises grinding the stone surface with a honing disc having a first grit, thereafter grinding the stone surface with a polishing disc having a second grit that is greater than the first grit, and thereafter burnishing the stone surface with a burnish pad having a third grit that is greater than the second grit.

65. A method of polishing a stone surface according to claim 64, wherein the stone surface is wet while grinding with the honing disc, the stone surface is dry while grinding with the polishing disc.

66. The method according to claim 64, wherein the burnishing pad is a first burnishing pad and the honing disc is releasably secured to a second burnish pad.

67. The method of polishing a stone surface according to claim 64, wherein the burnishing of the stone surface is a first burnishing, with a second burnishing being carried out after drying the film forming composition on the stone surface.

68. The method of claim 67, further comprising applying additional film forming composition to the stone surface after the surface is burnished with the second burnish pad.

69. The method of claim 68, further comprising securing a plurality of honing discs to the second burnish pad, with the grinding being carried out by rotating the second burnish pad.

70. The method according to claim 62, wherein the film forming composition comprises the polymer and the wax in a mass ratio of polymer to wax of about 1:1 to about 5:1.

71. The method according to claim 62, wherein the film forming composition has a total solids content of less than 15 percent.

72. The method according to claim 62, wherein the polymer comprises a plurality of monomer units, and wherein from 0 to 45 percent of the monomer units are styrene monomer units.

73. The method according to claim 62, wherein from 55 to 100 percent of the monomer units are acrylate monomer units, wherein each acrylate monomer unit is independently selected from methyl methacrylate, butyl acrylate, methacrylic acid, isobutyl methacrylate, 2-ethylhexylacrylate, and hydroxyethyl methacrylate.

74. The method according to claim 73, wherein the polymer has a glass transition temperature from 45° C. to 115° C.

75. The method according to claim 73, wherein the polymer has an acid number from 20 to 150.

76. The method according to claim 62, wherein the wax is selected from the group consisting of a polyethylene wax, a polypropylene wax, a beeswax, a carnauba wax, a paraffin wax, and combinations thereof.

77. The method according to claim 62, further comprising a polyvalent metal ion.

78. The method according to claim 62, wherein the liquid coating composition further comprises an additive selected from the group consisting of plasticizer, pH adjuster, wetting agent, defoamer, coalescing agent, preservative, dye, pigment, fragrance, optical component, nanoparticle, embedded particle, and combinations thereof.

79. The method according to claim 62, wherein the coating has a hardness between 30 and 70 on the König hardness scale one day after application.

80. The method according to claim 62, wherein the coating has a static coefficient of friction of at least 0.5 as measured by ASTM D2047 standard test method.

81. The method according to claim 64, wherein when the liquid film forming composition is applied to an uncoated stone floor surface having a glossiness from 5 to 45 at 20 degrees, from 20 to 75 at 60 degrees, and from 40 to 95 at 85 degrees, and the coating has a glossiness from 20 to 75 at 20 degrees, from 50 to 90 at 60 degrees, and from 55 to 100 at 85 degrees.

82. A method of polishing a stone surface, the method comprising:
(A) pre-treating the stone surface by burnishing the stone surface to form a pretreated stone surface;
(B) applying a liquid film forming composition to the stone surface, the liquid film forming composition having a polymer and a wax in a ratio of polymer to wax of from 1:1 to 5:1, the polymer comprising at least one of an acrylate polymer, a styrene-acrylate copolymer and a combination thereof, and
(C) drying the liquid film forming composition on the stone surface to form a coating having a thickness of from about 0.05 mil to about 0.27 mil.

83. A method of polishing a stone surface, the method comprising:
(A) pre-treating the stone surface by burnishing the stone surface to form a pretreated stone surface;
(B) applying a liquid film forming composition to the stone surface, the liquid film forming composition comprising a polymer and a wax, the polymer comprising at least one the polymer comprising at least one of an acrylate polymer, a styrene-acrylate copolymer and a combination thereof, the liquid film forming composition having a total solids content of less than 15 percent; and
(C) drying the liquid film forming composition on the stone surface to form a coating having a thickness of from about 0.05 mil to about 0.27 mil.
